(19) United States
(12) Patent Application Publication
(10) Pub. No.: US 2026/0227489 A1
(43) Pub. Date: Aug. 6, 2026

(54) Method of object classification, environmental sensor, and vehicle

(71) Applicant: AUMOVIO Autonomous Mobility Germany GmbH, Ingolstadt (DE)

(72) Inventor: Philippe Dintzer, Kressbronn (DE)

(73) Assignee: AUMOVIO Autonomous Mobility Germany GmbH, Ingolstadt (DE)

(21) Appl. No.: 19/460,394

(22) Filed: Jan. 27, 2026

(30) Foreign Application Priority Data
Jan. 31, 2025 (DE) 10 2025 103 555.5

(51) Int. Cl. G01S 7/41; G01S 13/58; G01S 13/931

(52) U.S. Cl. CPC G01S 7/411; G01S 13/58; G01S 13/931

(57) ABSTRACT

The invention relates to a method for object classification for an ego vehicle (1), comprising an environmental sensor for environmental detection, in particular a radar sensor (2, 9a-9d), wherein the environmental sensor emits signals which are reflected at objects and received again by the environmental sensor in order to determine their speed, relative speed or distance, wherein the signals reflected at a target object are reflected at least once from the ego vehicle (1) back to the target object, these being received again by the environmental sensor as an ego mirror signal, and it is determined whether a received signal is an ego mirror signal or not, and a series of signals that comprises the signal reflected by the target object as well as at least one ego mirror signal is determined for a target object, and the reflectivity of the signals reflected by the target object and ego mirror signals is determined, wherein a change in the ascertained reflectivity within the signal series and/or the number of received mirror measurements is used to classify the target objects.

### CROSS-REFERENCE TO RELATED APPLICATIONS

This application claims priority under 35 U.S.C. § 120 to German Patent Application No. 10 2025 103 555.5 filed on Jan. 31, 2025, the entire disclosure of which is incorporated by reference herein.

### FIELD OF THE INVENTION

The present invention relates to a method for object classification for an environmental sensor, an environmental sensor, in particular a radar sensor, for a vehicle and a vehicle that has an environmental sensor according to the invention.

### BACKGROUND OF THE INVENTION

Modern means of transport, such as motor vehicles or motorcycles, are increasingly being equipped with driver assistance systems that, with the aid of sensor systems, are able to capture the environment, recognize traffic situations and assist the driver, for example by braking or steering intervention or by outputting an optical or acoustic warning. Radar sensors, lidar sensors, camera sensors, ultrasonic sensors or the like are normally used as sensor systems for detecting the environment. Insights about the environment can then be obtained from the sensor data determined by the sensors. The detection of the environment by means of radar sensors is based on the emission of bundled electromagnetic waves and the reflection thereof, e.g. by other road users, obstacles on the roadway or the buildings on the edge of the roadway. The detection of pedestrians is often carried out with camera sensors, but radar sensors are also increasingly being used in this respect.

The radar sensors used for systems of the type described above are also often used in combination with sensors based on other technologies, such as camera or lidar sensors. One of the advantages of radar sensors is that they operate reliably even in bad weather conditions and can measure not only the distance of objects but also their radial relative speed directly by way of the Doppler effect. Usually, 24 GHz, 77 GHz and 79 GHz are used as transmission frequencies, but also other permissible frequencies will be used in the future. Owing to the increasing functional scope of such systems, the requirements, in particular with regard to the maximum detection range and the performance of the environmental classification, are constantly increasing. In addition to the detection of the environment surrounding motor vehicles for systems of the type described above, the focus is now also comprising the interior monitoring of motor vehicles, e.g. to detect which seats in the vehicle are occupied; frequencies in the 60 GHz range, for example, are used here.

The classification of the detected objects is of particular importance in modern radar sensors. For example, the classification of vehicles is made primarily on the basis of the measured dimension and reflectance of the observed or detected vehicle. In this context, for example, relatively large vehicles, such as for example trucks or vans, generate multiple or a comparatively large number of reflections in the sensor image. However, the actual extent of a vehicle cannot be clearly determined. For example, it cannot be established with certainty whether the detections involve a truck with a trailer or two passenger motor vehicles (cars) traveling at a short distance and at the same speed. This can result in an incorrect classification with adverse effects on different driving functions (control strategy, HMI presentation, etc.), with the result that the performance can be restricted and the acceptance by the vehicle user can be reduced. Therefore, in the case of radar sensors and radar detection methods, there is particular interest in correctly and robustly classifying the different vehicle types, such as passenger cars and trucks, wherein the different reflections from a single vehicle should be better grouped so that they produce a correct dimension. Furthermore, it should be made possible for a correct representation of the road user to be provided on a display of the sensor vehicle (e.g. Human-Machine Interface; HMI) and that an appropriate control strategy can be implemented for various driving functions (e.g. ACC or EBA).

Furthermore, the air attenuation can be estimated, e.g. by means of a statistical analysis of all measured reflections (received power) and the maximum distance of the measured reflections. The usual estimates, however, are generally inaccurate and depend very much on the observed environment and the driving situation.

### PUBLISHED PRIOR ART

DE 10 2020 121 108 A1, incorporated herein by reference, discloses a method for detecting road users in an environment of a vehicle, which method comprises determining detections that describe potential objects in the environment, identifying erroneous detections within the detections and recognizing the road users on the basis of the detections that are not the faulty detections. The identification of the erroneous detections further comprises, for each detection, the check, on the basis of the spatial position with respect to other detections, whether the detection is due to a reflection effect of a plurality of predefined reflection effects of the radar signal, wherein the plurality of predefined reflection effects describe at least one additional reflection of the radar signal after a first reflection of the radar signal by an object. Here, the effect of multiple reflection is described.

### SUMMARY OF THE INVENTION

Proceeding from the prior art, an aspect of the present invention is to provide a generic environmental sensor for object detection, in particular a radar sensor, with which an improvement in the object classification can be achieved in a simple and cost-effective manner.

In the method according to the invention for object classification for an ego vehicle, the latter first of all comprises an environmental sensor for environment capture or object detection, in particular a radar sensor, wherein e.g. a lidar sensor or ultrasonic sensor could also be provided. The environmental sensor emits signals which are reflected at objects and received again by the environmental sensor in order to determine the speed, relative speed and/or distance of the respective object or objects. The signals reflected at a target object are also reflected back to the target object at least once by the ego vehicle, and these are received again by the environmental sensor as an ego mirror signal. Furthermore, it is determined whether a received signal is an ego mirror signal or not. For a target object, a series of signals is then determined which comprises the signal reflected by the target object (i.e. the original detection signal) and at least one or more ego mirror signals. The reflectivity of the signals and ego mirror signals reflected by the target object is then determined, wherein a change in the determined reflectivity within the signal series (or along the time profile of the signal series) and/or the number of received mirror measurements is used for object classification of the target objects.

The method according to the invention does not necessarily require the build-up of a history and can be applied directly to detections which are not tracked (RDI classification). The application of this method over several cycles in combination with temporal filtering can nevertheless lead to a further increase in classification performance and classification robustness. In addition, a direct measurement of air attenuation can be performed. Furthermore, in comparison with the prior art (in particular DE 10 2020 121 108 A1), in which no indication is made of the determination of a reflectance of the vehicle and the target object, an independent new physical variable (than in the case of conventional methods) can be taken into account and supplementary criteria can be used for a robust classification of the road users (vulnerable users (VRU), cars, trucks, vans, SUVs or the like), to improve classification.

Preferably, the reflectivity can be determined on the basis of the detected power of the signal (e.g. also on the basis of the RCS (radar cross section) value or reflection area or effective reflection surface).

Expediently, the signal series can be ascertained on the basis of the determined speed and/or the determined relative speed and/or the determined distance of the target object.

According to a particular design of the method according to the invention it is determined whether the signal received by the environmental sensor is an ego mirror reflection in that an ascertained distance of the object and/or an ascertained speed of the object and/or an ascertained relative speed of the object are/is a multiple of the actual relative speed and of the actual distance of the first received measurement.

According to a preferred configuration of the invention, attenuation or air attenuation can also be determined by determining the power of at least two ego mirror signals from a signal series for a target object, wherein a reduction of the received power between two ego mirror signals is used.

According to a preferred configuration of the invention, at least two, preferably at least three, different road user classes, in particular VRU (vulnerable road users), passenger cars, and trucks (trucks and vans) can be distinguished in the object classification on the basis of a change in the determined reflectivity within the signal series and/or the number of received mirror measurements within the signal series.

Furthermore, the invention also relates to an environmental sensor, in particular a radar sensor (or also a lidar sensor, camera sensor or ultrasonic sensor) for object identification or environmental detection for a vehicle or ego vehicle, the sensor data of which are used to perform an object classification, wherein the object classification is performed on the basis of the method according to the invention.

In addition, the present invention claims a vehicle which has an environmental sensor according to the invention, in particular a radar sensor.

### BRIEF DESCRIPTION OF EXEMPLARY EMBODIMENTS

The invention is described in more detail below on the basis of advantageous exemplary embodiments. In particular:

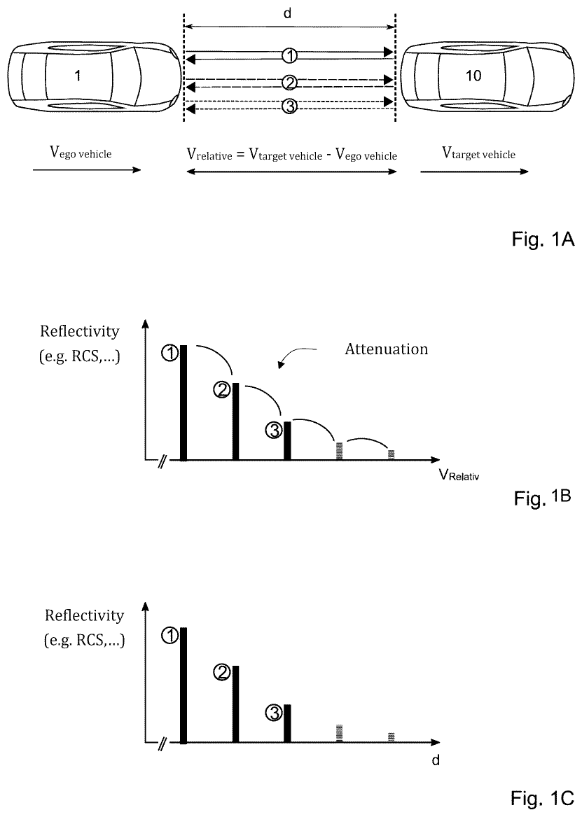

FIG. 1A shows a simplified schematic illustration of the reflections of the ego vehicle on another vehicle, wherein (1) the original reflection and (2) and (3) each represent ego mirror reflections that each have a lower power than the preceding measurement;

FIG. 1B shows a simplified illustration of the attenuation of reflectivity due to vehicle reflections and attenuation from measurement to measurement within a signal series, comprising the signal reflected by the target object as well as two ego mirror signals (2) and (3) and two further indicated ego mirror signals, wherein the signal series is determined on the basis of the determined relative speed;

FIG. 1C shows a simplified illustration of the attenuation of reflectivity due to vehicle reflections and attenuation from measurement to measurement within a signal series, comprising the signal reflected by the target object as well as two ego mirror signals (2) and (3) and two further indicated ego mirror signals, wherein the signal series is determined on the basis of the determined distance from the target vehicle; and

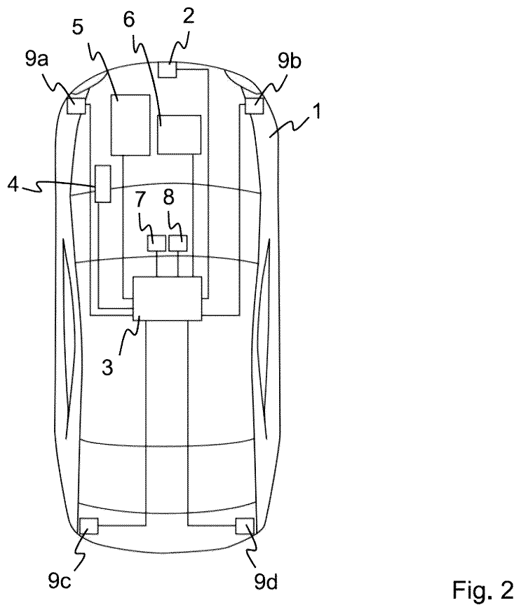

FIG. 2 shows a simplified illustration of an embodiment of an ego vehicle according to the invention.

### DETAILED DESCRIPTION OF EXEMPLARY EMBODIMENTS

The invention is based on the principle that signals comprising microwaves that are transmitted by a radar are reflected by other road users and received again by the same radar. The ego vehicle that comprises or carries the radar sensor can, however, also become a reflector itself, so that it once again reflects these waves away from itself to the other road users, which again reflect these waves back. Such a reflection of the ego vehicle (“egomirror” or “ego mirror”) accordingly results, from a single transmitted microwave, in a plurality of measurements or detections, as illustrated in FIG. 1A on the basis of the ego vehicle 1 and the target object or a further vehicle 10 driving ahead at a (relative) distance d. However, each new measurement of the reflected microwave loses power due to the reflectivity of the two vehicles 1, 10 involved and the propagation of the waves through the air (i.e. attenuation), as shown in FIG. 1B on the basis of the measured relative speed Vᵣₑₗₐₜᵢᵥₑ and in FIG. 1C on the basis of the determined distance d between the vehicles 1, 10. These reflections can be easily and robustly identified, since a measured or ascertained distance d from the target object and/or a measured or ascertained relative speed Vᵣₑₗₐₜᵢᵥₑ to the target object are a multiple of the actual distance to the target object or of the actual relative speed of the target object or of the first measurement (or of the signal reflected back received from the target object).

This principle can now be used for vehicle classification in that weak and diffusely reflecting road users (such as, for example, VRU, such as pedestrians, cyclists, animals and the like) produce little to no mirror measurements from the driver's own vehicle. By contrast, the situation is different with tall and/or increasingly metal-made road users, such as cars or trucks, for whom significantly more mirror measurements are produced by the driver's own vehicle. However, the form of the target vehicle also has a strong influence on the number of received measurements or mirror measurements. A wide and smooth reflective surface, such as in vans or closed truck trailers, generates a higher number of ego mirror reflections than a conventional car. Therefore, e.g. three different classes of road users could be distinguished: VRU, passenger cars, and trucks/transporters.

The ego mirror reflection observation could also be used for other technologies, such as FMCW (frequency modulated continuous wave) lidar or the like.

FIG. 2 shows a vehicle or ego vehicle 1 according to the invention, which has a radar sensor 2 according to the invention for object detection or environmental detection. In this case, reference numeral 2 denotes a control device (ECU, electronic control unit or ADCU, assisted and automated driving control unit) by means of which sensor control, sensor data combination, environment and/or object recognition, trajectory planning and/or vehicle control can be carried out, in particular (partially) autonomously. For vehicle control, the control device 3 can access different actuators (steering system 4, motor 5, brake 6). In addition to the radar sensor 2, the vehicle 1 also has further sensors (lidar sensor 7, camera 8 and radar sensors 9a-9d) for environmental detection. The sensor data can advantageously be used to detect the environment and objects, such that various assistance functions, such as emergency brake assist (EBA), adaptive cruise control (ACC), lane keeping or lane keep assist (LKA) or the like, can be implemented. In addition, the assistance functions can likewise be executed by means of the control device 3 or another control unit provided for this purpose.

### LIST OF REFERENCE NUMERALS

1 ego vehicle
2 radar sensor
3 control device
4 steering system
5 motor
6 brake
7 lidar sensor
8 camera
9a-9d radar sensor
10 other vehicle

1. A method for object classification for an ego vehicle, comprising an environmental sensor for detecting the environment, wherein
the environmental sensor emits signals which are reflected at objects and received again by the environmental sensor, to determine their speed, relative speed or distance, wherein
the signals reflected at a target object are reflected back to the target object at least once by the ego vehicle, wherein
these are received again by the environmental sensor as an ego mirror signal, and
it is determined whether a received signal is an ego mirror signal or not, and
a series of signals that comprises the signal reflected by the target object and at least one ego mirror signal is determined for a target object, and
the reflectivity of the signals reflected by the target object and ego mirror signals is determined, wherein
a change in the ascertained reflectivity within the signal series and/or the number of received mirror measurements is used to classify the target objects.

2. The method according to claim 1, wherein the reflectivity is determined on the basis of the detected power of the signal.

3. The method according to claim 1, wherein the series of signals is ascertained on the basis of the determined speed and/or the determined relative speed and/or the determined distance of the target object.

4. The method according to claim 1, wherein it is determined whether the signal received by the environmental sensor is an ego mirror reflection in that an ascertained distance of the object and/or an ascertained relative speed of the object are a multiple of the actual relative speed and of the actual distance of the first received measurement.

5. The method according to claim 1, wherein in the object classification it can be distinguished between at least two, different road user classes, in particular VRU, passenger cars and trucks/transporters on the basis of a change in the determined reflectivity within the signal series and/or the number of received mirror measurements within the signal series.

6. An environmental sensor, for object recognition for an ego vehicle, the sensor data of which are used to perform an object classification, wherein the object classification takes place by a method according to claim 1.

7. An ego vehicle, having an environmental sensor, according to claim 6.

8. The method according to claim 1, wherein the environmental sensor is a radar sensor.

9. The environmental sensor, of claim 6, wherein the environmental sensor is a radar sensor.
